(19) United States
(12) Patent Application Publication
(10) Pub. No.: US 2020/0150663 A1
(43) Pub. Date: May 14, 2020

(54) DATA STITCHING FOR UPDATING 3D RENDERINGS FOR AUTONOMOUS VEHICLE NAVIGATION

(71) Applicant: TOYOTA MOTOR NORTH AMERICA, INC., Plano, TX (US)

(72) Inventor: Devang PAREKH, Dallas, TX (US)

(21) Appl. No.: 16/184,936

(22) Filed: Nov. 8, 2018

(51) Int. Cl. G05D 1/02; G05D 1/00; G06T 15/00

(52) U.S. Cl. CPC G05D 1/0212; G05D 1/0088; H04W 4/40; G05D 2201/0213; G06T 15/00

(57) ABSTRACT

An autonomous vehicle and method are provided. The autonomous vehicle includes a memory to store a three-dimensional (3D) rendering of an environment surrounding the autonomous vehicle; one or more sensors of the autonomous vehicle to collect real-time data describing the environment surrounding the autonomous vehicle; and a processor to (i) revise the 3D rendering according to the real-time data, and (ii) navigate the autonomous vehicle according to the revised 3D rendering.

### TECHNICAL FIELD

The present disclosure relates generally to vehicles. In particular, embodiments of the present disclosure relate to autonomous vehicle navigation.

### DESCRIPTION OF RELATED ART

Recent advancements have led to autonomous vehicles that can navigate the roadways with little or no input from an occupant of the vehicle. Many of these autonomous vehicles navigate according to realistic 3-D computer renderings of the environment surrounding the autonomous vehicle.

### BRIEF SUMMARY OF THE DISCLOSURE

In general, one aspect disclosed features an autonomous vehicle comprising: a memory to store a three-dimensional (3D) rendering of an environment surrounding the autonomous vehicle; one or more sensors of the autonomous vehicle to collect real-time data describing the environment surrounding the autonomous vehicle; and a processor to (i) revise the 3D rendering according to the real-time data, and (ii) navigate the autonomous vehicle according to the revised 3D rendering.

Embodiments of the autonomous vehicle may include one or more of the following features. Some embodiments comprise a wireless receiver to receive static data describing static features of the environment surrounding the autonomous vehicle; wherein the processor is further to (i) revise the 3D rendering according to the static data, and (ii) navigate the autonomous vehicle according to the revised 3D rendering. In some embodiments, the wireless receiver is further to receive the static data from at least one of: other vehicles; and stationary transmitters. Some embodiments comprise a wireless receiver to receive further real-time data; wherein the processor is further to (i) revise the 3D rendering according to the further real-time data, and (ii) navigate the autonomous vehicle according to the revised 3D rendering. In some embodiments, the wireless receiver is further to receive the further real-time data from at least one of: other vehicles; and stationary transmitters. Some embodiments comprise a wireless receiver to receive incremental updates to the 3D rendering; wherein the processor is further to revise the 3D rendering according to the real-time data and the incremental updates. Some embodiments comprise a wireless transmitter to transmit the real-time data to a remote server storing a further 3D rendering; wherein the remote server revises the further 3D rendering according to the real-time data.

In general, one aspect disclosed features a method for an autonomous vehicle, the method comprising: accessing a three-dimensional (3D) rendering of an environment surrounding the autonomous vehicle; collecting real-time data describing the environment surrounding the autonomous vehicle; revising the 3D rendering according to the real-time data; and navigating the autonomous vehicle according to the revised 3D rendering.

Embodiments of the method may include one or more of the following features. Some embodiments comprise receiving static data describing static features of the environment surrounding the autonomous vehicle; revising the 3D rendering according to the static data; and navigating the autonomous vehicle according to the revised 3D rendering. Some embodiments comprise at least one of: receiving the static data from other vehicles; and receiving the static data from stationary transmitters. Some embodiments comprise receiving further real-time data; revising the 3D rendering according to the further real-time data; and navigating the autonomous vehicle according to the revised 3D rendering. Some embodiments comprise at least one of: receiving the further real-time data from other vehicles; and receiving the further real-time data from stationary transmitters. Some embodiments comprise receiving incremental updates to the 3D rendering; and revising the 3D rendering according to the real-time data and the incremental updates.

In general, one aspect disclosed features a non-transitory machine-readable storage medium encoded with instructions executable by a hardware processor of a computing component of a vehicle, the machine-readable storage medium comprising instructions to cause the hardware processor to perform a method for an autonomous vehicle, the method comprising: accessing a three-dimensional (3D) rendering of an environment surrounding the autonomous vehicle; collecting real-time data describing the environment surrounding the autonomous vehicle; revising the 3D rendering according to the real-time data; and navigating the autonomous vehicle according to the revised 3D rendering.

Embodiments of the medium may include one or more of the following features. Some embodiments comprise receiving static data describing static features of the environment surrounding the autonomous vehicle; revising the 3D rendering according to the static data; and navigating the autonomous vehicle according to the revised 3D rendering. Some embodiments comprise at least one of: receiving the static data from other vehicles; and receiving the static data from stationary transmitters. Some embodiments comprise receiving further real-time data; revising the 3D rendering according to the further real-time data; and navigating the autonomous vehicle according to the revised 3D rendering. Some embodiments comprise at least one of: receiving the further real-time data from other vehicles; and receiving the further real-time data from stationary transmitters. Some embodiments comprise receiving incremental updates to the 3D rendering; and revising the 3D rendering according to the real-time data and the incremental updates. Some embodiments comprise transmitting the real-time data to a remote server storing a further 3D rendering; wherein the remote server revises the further 3D rendering according to the real-time data.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example vehicle in which embodiments of the disclosed technology may be implemented.

FIG. 2 illustrates an example architecture for data stitching for updating 3D renderings for autonomous vehicle navigation in accordance with one embodiment of the systems and methods described herein.

FIG. 3 is a flowchart illustrating a process for data stitching for updating 3D renderings for autonomous vehicle navigation according to one embodiment.

FIG. 4 graphically illustrates a 3D rendering for an autonomous vehicle according to some embodiments.

FIG. 5 shows an example computing component capable of carrying out the functionality described with respect thereto.

The figures are not exhaustive and do not limit the present disclosure to the precise form disclosed.

### DETAILED DESCRIPTION

Various embodiments are directed to systems and methods for data stitching for updates of 3D renders for autonomous vehicle navigation. Data stitching refers to the combination of data, which may have overlapping sections, and which may be drawn from multiple sources, to create a single data set. In the described embodiments, the resulting data set is a realistic three-dimensional (3D) rendering. The 3D rendering may represent an environment of an autonomous vehicle, and may be used by the autonomous vehicle for navigation.

In some embodiments, an autonomous vehicle includes a mapping system that stores a 3D rendering of the environment surrounding the autonomous vehicle, and sensors that collect real-time data describing the environment surrounding the autonomous vehicle. The mapping system revises the 3D rendering according to the real-time data. That is, the mapping system stitches together the 3D rendering and the real-time data. An autonomous driving system navigates the vehicle according to the revised 3D rendering.

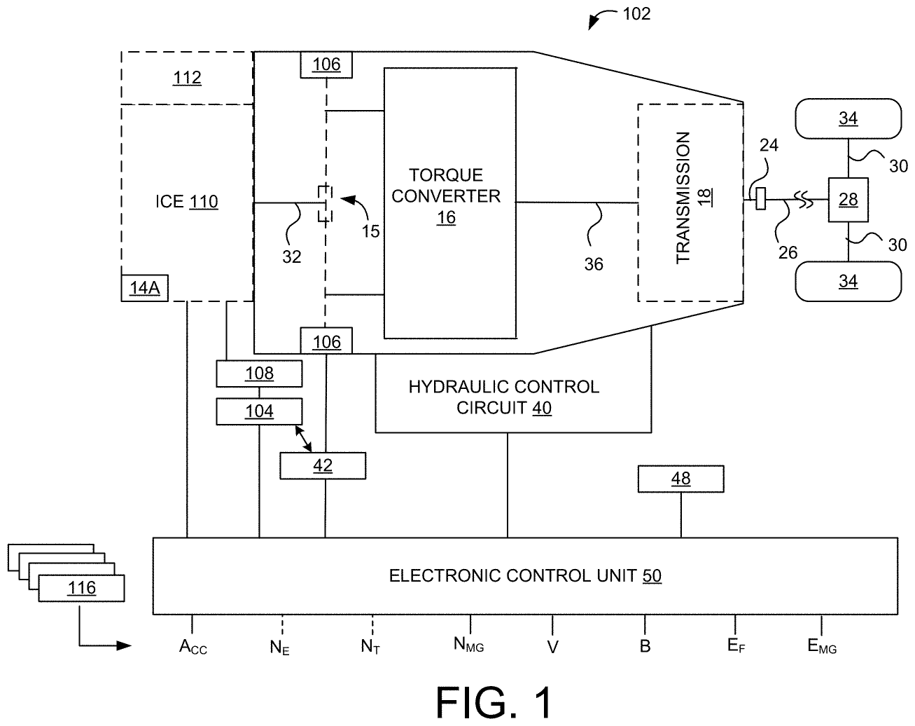

An example autonomous vehicle 102 in which embodiments of the disclosed technology may be implemented is illustrated in FIG. 1. The autonomous vehicle depicted in FIG. 1 is a hybrid electric vehicle. However, the disclosed technology is independent of the means of propulsion of the vehicle, and so applies equally to vehicles without an electric motor, and to vehicles without an internal combustion engine.

FIG. 1 illustrates a drive system of a vehicle 102 that may include an internal combustion engine 110 and one or more electric motors 106 (which may also serve as generators) as sources of motive power. Driving force generated by the internal combustion engine 110 and motor 106 can be transmitted to one or more wheels 34 via a torque converter 16, a transmission 18, a differential gear device 28, and a pair of axles 30.

As an HEV, vehicle 102 may be driven/powered with either or both of engine 110 and the motor(s) 106 as the drive source for travel. For example, a first travel mode may be an engine-only travel mode that only uses internal combustion engine 110 as the drive source for travel. A second travel mode may be an EV travel mode that only uses the motor(s) 106 as the drive source for travel. A third travel mode may be an HEV travel mode that uses engine 110 and the motor(s) 106 as drive sources for travel. In the engine-only and HEV travel modes, vehicle 102 relies on the motive force generated at least by internal combustion engine 110, and a clutch 15 may be included to engage engine 110. In the EV travel mode, vehicle 102 is powered by the motive force generated by motor 106 while engine 110 may be stopped and clutch 15 disengaged.

Engine 110 can be an internal combustion engine such as a spark ignition (SI) engine (e.g., gasoline engine) a compression ignition (CI) engine (e.g., diesel engine) or similarly powered engine (whether reciprocating, rotary, continuous combustion or otherwise) in which fuel is injected into and combusted to provide motive power. A cooling system 112 can be provided to cool the engine such as, for example, by removing excess heat from engine 110. For example, cooling system 112 can be implemented to include a radiator, a water pump and a series of cooling channels. In operation, the water pump circulates coolant through the engine to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 110. In other applications, either or both the water pump and the fan may be operated by electric current such as from battery 104.

An output control circuit 14A may be provided to control drive (output torque) of engine 110. Output control circuit 14A may include a throttle actuator to control an electronic throttle valve that controls fuel injection, an ignition device that controls ignition timing, and the like. Output control circuit 14A may execute output control of engine 110 according to a command control signal(s) supplied from an electronic control unit 50, described below. Such output control can include, for example, throttle control, fuel injection control, and ignition timing control.

Motor 106 can also be used to provide motive power in vehicle 102, and is powered electrically via a battery 104. Battery 104 may be implemented as one or more batteries or other power storage devices including, for example, lead-acid batteries, lithium ion batteries, capacitive storage devices, and so on. Battery 104 may be charged by a battery charger 108 that receives energy from internal combustion engine 110. For example, an alternator or generator may be coupled directly or indirectly to a drive shaft of internal combustion engine 110 to generate an electrical current as a result of the operation of internal combustion engine 110. A clutch can be included to engage/disengage the battery charger 108. Battery 104 may also be charged by motor 106 such as, for example, by regenerative braking or by coasting during which time motor 106 operate as generator.

Motor 106 can be powered by battery 104 to generate a motive force to move the vehicle and adjust vehicle speed. Motor 106 can also function as a generator to generate electrical power such as, for example, when coasting or braking. Battery 104 may also be used to power other electrical or electronic systems in the vehicle. Motor 106 may be connected to battery 104 via an inverter 42. Battery 104 can include, for example, one or more batteries, capacitive storage units, or other storage reservoirs suitable for storing electrical energy that can be used to power motor 106. When battery 104 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 106, and adjust the current received from motor 106 during regenerative coasting and breaking. As a more particular example, output torque of the motor 106 can be increased or decreased by electronic control unit 50 through the inverter 42.

A torque converter 16 can be included to control the application of power from engine 110 and motor 106 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 110 from the drivetrain of the vehicle. In the illustrated example, a crankshaft 32, which is an output member of engine 110, may be selectively coupled to the motor 106 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 110 is not delivered to the torque converter 16. In a slip engagement state, clutch 15 is engaged, and motive power is provided to torque converter 16 according to a torque capacity (transmission torque) of the clutch 15.

As alluded to above, vehicle 102 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 102. For example, electronic control unit 50 may receive signals that indicate vehicle operating conditions or characteristics, or signals that can be used to derive vehicle operating conditions or characteristics. These may include, but are not limited to accelerator operation amount, A_{CC}, a revolution speed, N_{E}, of internal combustion engine 110 (engine RPM), a rotational speed, N_{MG}, of the motor 106 (motor rotational speed), and vehicle speed, N_{V}. These may also include torque converter 16 output, N_{T} (e.g., output amps indicative of motor output), brake operation amount/pressure, B, battery SOC (i.e., the charged amount for battery 104 detected by an SOC sensor). Accordingly, vehicle 102 can include a plurality of sensors 116 that can be used to detect various conditions internal or external to the vehicle and provide sensed conditions to engine control unit 50 (which, again, may be implemented as one or a plurality of individual control circuits). In one embodiment, sensors 116 may be included to detect one or more conditions directly or indirectly such as, for example, fuel efficiency, E_{F}, motor efficiency, E_{MG}, hybrid (internal combustion engine 110+MG 12) efficiency, etc.

In some embodiments, one or more of the sensors 116 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 116 may provide an analog output or a digital output.

Sensors 116 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, the presence or absence of a road shoulder and so on. Still other sensors may include those that can detect road grade. While some sensors can be used to actively detect passive environmental objects, other sensors can be included and used to detect active objects such as those objects used to implement smart roadways that may actively transmit and/or receive data or other information.

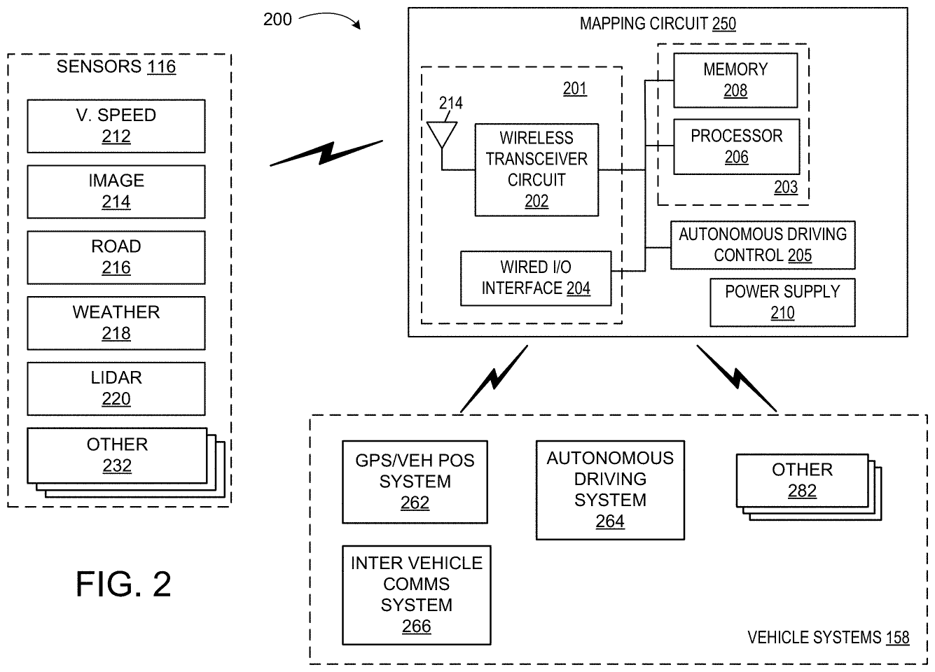

FIG. 2 illustrates an example architecture for data stitching for updating 3D renderings for autonomous vehicle navigation in accordance with one embodiment of the systems and methods described herein. Referring now to FIG. 2, in this example, a navigation system 200 includes an mapping circuit 250, a plurality of sensors 116, and a plurality of vehicle systems 158. Sensors 116 and vehicle systems 158 can communicate with mapping circuit 250 via a wired or wireless communication interface. Although sensors 116 and vehicle systems 158 are depicted as communicating with mapping circuit 250, they can also communicate with each other as well as with other vehicle systems. Mapping circuit 250 can be implemented as an ECU or as part of an ECU such as, for example electronic control unit 50. In other embodiments, mapping circuit 250 can be implemented independently of the ECU.

Mapping circuit 250 in this example includes a communication circuit 201, a processing circuit 203 (including a processor 206 and memory 208 in this example) and a power supply 210. Components of mapping circuit 250 are illustrated as communicating with each other via a data bus, although other communication interfaces can be included. Mapping circuit 250 in this example also includes an autonomous driving control 205 that can be operated by the user to control the mapping circuit 250, for example by manual controls, voice, and the like.

Processor 206 can include a GPU, CPU, microprocessor, or any other suitable processing system. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to operate mapping circuit 250.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up an mapping circuit 250.

Communication circuit 201 either or both a wireless transceiver circuit 202 with an associated antenna 214 and a wired I/O interface 204 with an associated hardwired data port (not illustrated). As this example illustrates, communications with mapping circuit 250 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by mapping circuit 250 to/from other entities such as sensors 116 and vehicle systems 158.

Wired I/O interface 204 can include a transmitter and a receiver (not shown) for hardwired communications with other devices. For example, wired I/O interface 204 can provide a hardwired interface to other components, including sensors 116 and vehicle systems 158. Wired I/O interface 204 can communicate with other devices using Ethernet or any of a number of other wired communication protocols whether standardized, proprietary, open, point-to-point, networked or otherwise.

Power supply 210 can include one or more of a battery or batteries (such as, e.g., Li-ion, Li-Polymer, NiMH, NiCd, NiZn, NiH₂, rechargeable, primary battery, etc.), a power connector (e.g., to connect to vehicle supplied power, etc.), an energy harvester (e.g., solar cells, piezoelectric system, etc.), or include any other suitable power supply.

Sensors 116 may include additional sensors that may or not otherwise be included on a standard vehicle 102 with which the accident prediction system 200 is implemented. In the illustrated example, sensors 116 include vehicle speed sensor 222, image sensor 224, road sensor 226, weather sensor 228, and lidar 220. Additional sensors 232 can also be included as may be appropriate for a given implementation of accident prediction system 200.

Vehicle systems 158 can include any of a number of different vehicle components or subsystems used to control or monitor various aspects of the vehicle and its performance. In this example, the vehicle systems 158 include a vehicle position system 262, an autonomous driving system 264, an inter-vehicle communications system 266, and other vehicle systems 282. Vehicle position system 262 may determine a geographic position of the vehicle, as well as its direction and speed. Vehicle position system 262 may include a global positioning satellite (GPS) system or the like. The autonomous driving system 264 may operate the vehicle 102 in any autonomous driving mode. The inter-vehicle communications system 266 performs automatic vehicle-to-vehicle radio communications to exchange data as described herein, and may include a dedicated short-range communications (DSRC) device or the like.

During operation, mapping circuit 250 can receive information from various vehicle sensors to determine whether the autonomous driving mode should be activated. Also, the driver may manually activate the autonomous driving mode by operating autonomous driving control 205. Communication circuit 201 can be used to transmit and receive information between mapping circuit 250 and sensors 116, and mapping circuit 250 and vehicle systems 158. Also, sensors 116 may communicate with vehicle systems 158 directly or indirectly (e.g., via communication circuit 201 or otherwise).

In various embodiments, communication circuit 201 can be configured to receive data and other information from sensors 116 that is used in determining whether to activate the autonomous driving mode. Additionally, communication circuit 201 can be used to send an activation signal or other activation information to various vehicle systems 158 as part of entering the autonomous driving mode. For example, as described in more detail below, communication circuit 201 can be used to send signals to, for example, the autonomous driving system 274. Examples of this are described in more detail below.

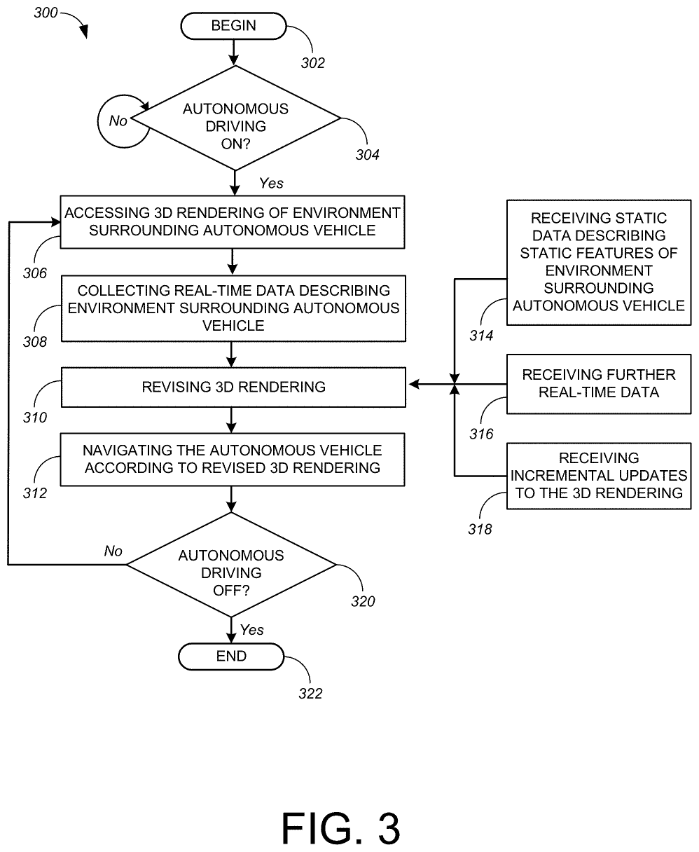

FIG. 3 is a flowchart illustrating a process 300 for data stitching for updating 3D renderings for autonomous vehicle navigation according to one embodiment. Referring to FIG. 3, the process 300 begins, at 302. The mapping circuit 250 first determines whether the autonomous driving mode is on, at 304. This may include determining whether the autonomous driving mode has been activated, for example manually by the driver using the autonomous driving control 205 to engage the autonomous driving mode. The mapping circuit 250 continues this determination until the autonomous driving mode is activated. In other embodiments, the mapping circuit 250 operates whether autonomous driving mode is engaged or not.

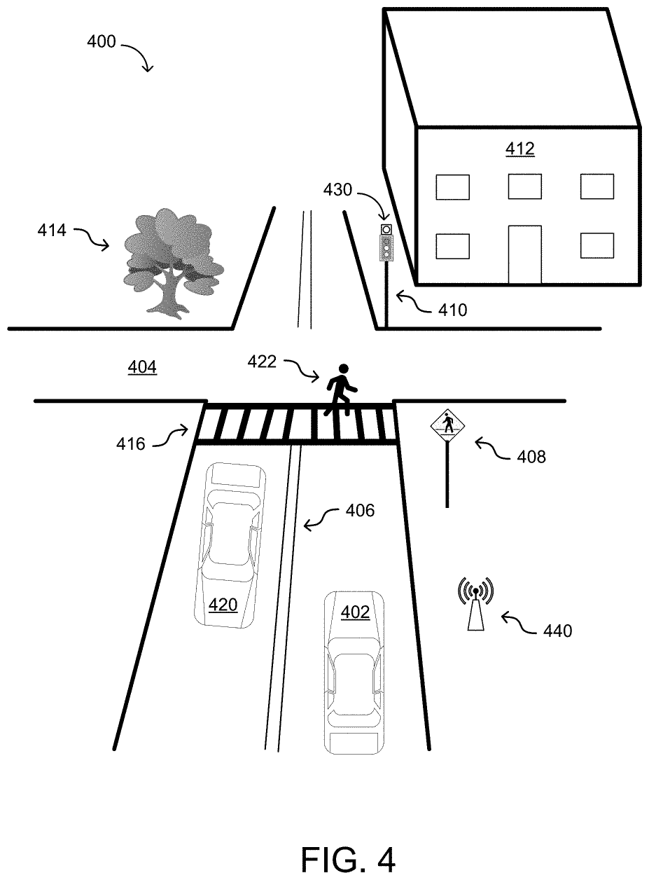

Referring again to FIG. 3, when the autonomous driving mode is active, the mapping circuit 250 accesses a three-dimensional (3D) rendering of an environment surrounding the autonomous vehicle, at 304. The 3D rendering may be stored, for example, in the memory 208 of the mapping circuit 250. FIG. 4 graphically illustrates a 3D rendering 400 for an autonomous vehicle 402 according to some embodiments. The 3D rendering generally includes static objects. For example, referring to FIG. 4, the 3D rendering 400 includes roadway lane markings 406, a street sign 408, a traffic signal 410, a building 412, and the like.

Referring again to FIG. 3, when the autonomous driving mode is active, the mapping circuit 250 collects real-time data describing the environment surrounding the autonomous vehicle, at 306. The real-time data may be collected by the sensors 116 of the vehicle 102. For example, image data may be collected by the image sensor 214. Lidar data may be collected by the lidar system 220. The real-time data may represent new static features and new dynamic features. For example, referring again to FIG. 4, the new dynamic features may include a vehicle 420, and a pedestrian 422 traversing the pedestrian crosswalk 416.

The vehicle 402 may also receive data describing features of the environment surrounding the autonomous vehicle from other sources. For example, referring again to FIG. 4, the data may be received from other vehicles 420, from stationary transmitters 440, from stationary sensors such as traffic light camera 430, and the like. The other vehicles 420 may provide the data via vehicle-to-vehicle communications. The data may be received by the inter-vehicle communications system 266 of the vehicle 102. The stationary transmitters 440 may provide the data from sources in the cloud, for example including remote networked servers.

The received data may include static data describing static features of the environment surrounding the autonomous vehicle, at 314. For example, referring again to FIG. 4, the static features may include a tree 414, a pedestrian crosswalk 416, and the like.

The received data may include further real-time data, at 316. The further real-time data may include any of the types of real-time data collected by the vehicle 402.

The received data may include updates to the 3D rendering, at 318. The updates may be provided by cloud servers storing reference 3D renderings, data representing the static features, and the like. In some embodiments, the updates are selectively performed, which can reduce latency associated with re-rendering to reflect updated information. For example, updates may be incremental, that is, restricted to changes in the reference 3D rendering. The entire environment may not require reconstruction, only the identifiable changes in the environment.

The reference 3D renderings stored in the cloud may be updated with static data collected and received by vehicles 102. For example, the vehicle 102 may transmit the real-time data to a remote server storing the reference 3D renderings. The remote server may then update the reference 3D rendering. In some embodiments, a big data approach may be employed by collecting large amounts of data from many vehicles of the same or different makes, models, and years, and in many locations, and using that data to train one or more analytics models. The model(s) may be used to analyze data subsequently collected, and to optimize the reference 3D renderings accordingly.

As the vehicle 402 collects real-time data and receives real-time data, the mapping circuit 250 may add features represented by the real-time data to the 3D rendering 400, at 310. In this disclosure, the process of adding features, whether static or dynamic, to the 3D rendering 400 is referred to as “revising” the 3D rendering 400, or “data stitching” the new features and the 3D rendering 400 together.

When the autonomous driving mode is active, the mapping circuit 250 navigates the autonomous vehicle 402 according to the revised 3D rendering 400, at 312. For example, the autonomous driving system 264 may operate the autonomous vehicle 402 in an autonomous driving mode under the control of the mapping circuit 250. The autonomous driving system 264 may operate the autonomous vehicle 402 in any autonomous driving mode. For example, the autonomous driving modes may include any of the modes defined by the SAE (J3016) Automation Levels standard.

The mapping circuit 250 occasionally determines whether the autonomous driving mode has been deactivated, at 320. While the autonomous driving mode is active, the mapping circuit 250 continues to collect data describing the environment surrounding the autonomous vehicle, revise the 3D rendering, and navigate the autonomous vehicle according to the 3D rendering. When the autonomous driving mode is deactivated, the process 300 ends, at 322.

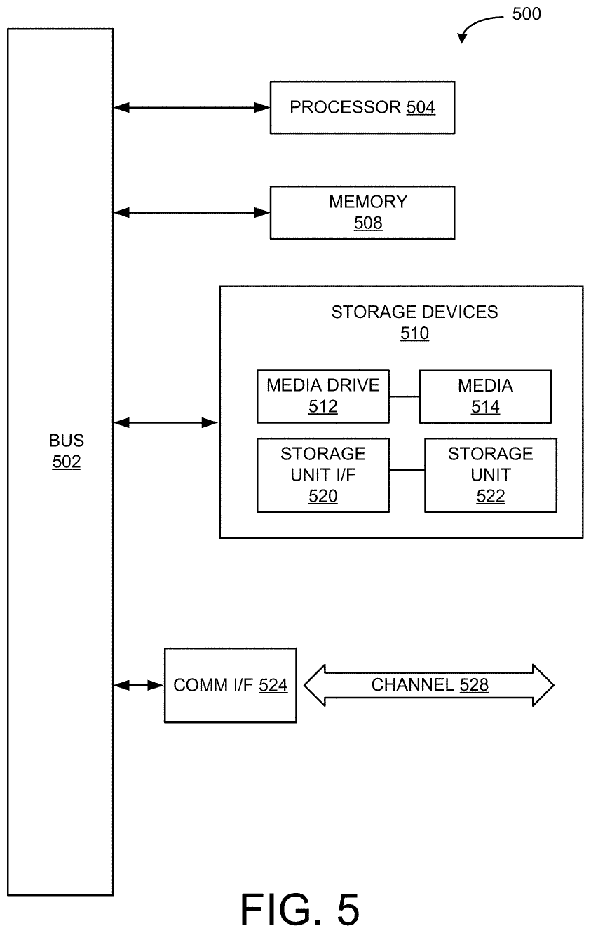

As used herein, the term component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up hybrid vehicle 102 and its component parts, for example such as the computing component. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as an Ethernet, network interface card, WiMedia, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “machine-readable storage medium,” “computer program medium,” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An autonomous vehicle comprising:
a memory to store a three-dimensional (3D) rendering of an environment surrounding the autonomous vehicle;
one or more sensors of the autonomous vehicle to collect real-time data describing the environment surrounding the autonomous vehicle; and
a processor to
(i) revise the 3D rendering according to the real-time data, and
(ii) navigate the autonomous vehicle according to the revised 3D rendering.

2. The autonomous vehicle of claim 1, further comprising:
a wireless receiver to receive static data describing static features of the environment surrounding the autonomous vehicle;
wherein the processor is further to
(i) revise the 3D rendering according to the static data, and
(ii) navigate the autonomous vehicle according to the revised 3D rendering.

3. The autonomous vehicle of claim 2, wherein the wireless receiver is further to receive the static data from at least one of:
other vehicles; and
stationary transmitters.

4. The autonomous vehicle of claim 1, further comprising:
a wireless receiver to receive further real-time data;
wherein the processor is further to
(i) revise the 3D rendering according to the further real-time data, and
(ii) navigate the autonomous vehicle according to the revised 3D rendering.

5. The autonomous vehicle of claim 4, wherein the wireless receiver is further to receive the further real-time data from at least one of:
other vehicles; and
stationary transmitters.

6. The autonomous vehicle of claim 1, further comprising:
a wireless receiver to receive incremental updates to the 3D rendering;
wherein the processor is further to revise the 3D rendering according to the real-time data and the incremental updates.

7. The autonomous vehicle of claim 1, further comprising:
a wireless transmitter to transmit the real-time data to a remote server storing a further 3D rendering;
wherein the remote server revises the further 3D rendering according to the real-time data.

8. A method for an autonomous vehicle, the method comprising:
accessing a three-dimensional (3D) rendering of an environment surrounding the autonomous vehicle;
collecting real-time data describing the environment surrounding the autonomous vehicle;
revising the 3D rendering according to the real-time data; and
navigating the autonomous vehicle according to the revised 3D rendering.

9. The method of claim 8, further comprising:
receiving static data describing static features of the environment surrounding the autonomous vehicle;
revising the 3D rendering according to the static data; and
navigating the autonomous vehicle according to the revised 3D rendering.

10. The method of claim 9, further comprising at least one of:
receiving the static data from other vehicles; and
receiving the static data from stationary transmitters.

11. The method of claim 8, further comprising:
receiving further real-time data;
revising the 3D rendering according to the further real-time data; and
navigating the autonomous vehicle according to the revised 3D rendering.

12. The method of claim 11, further comprising at least one of:
receiving the further real-time data from other vehicles; and
receiving the further real-time data from stationary transmitters.

13. The method of claim 8, further comprising:
receiving incremental updates to the 3D rendering; and
revising the 3D rendering according to the real-time data and the incremental updates.

14. A non-transitory machine-readable storage medium encoded with instructions executable by a hardware processor of a computing component of a vehicle, the machine-readable storage medium comprising instructions to cause the hardware processor to perform a method for an autonomous vehicle, the method comprising:
accessing a three-dimensional (3D) rendering of an environment surrounding the autonomous vehicle;
collecting real-time data describing the environment surrounding the autonomous vehicle;
revising the 3D rendering according to the real-time data; and
navigating the autonomous vehicle according to the revised 3D rendering.

15. The medium of claim 14, further comprising:
receiving static data describing static features of the environment surrounding the autonomous vehicle;
revising the 3D rendering according to the static data; and
navigating the autonomous vehicle according to the revised 3D rendering.

16. The medium of claim 15, further comprising at least one of:
receiving the static data from other vehicles; and
receiving the static data from stationary transmitters.

17. The medium of claim 14, further comprising:
receiving further real-time data;
revising the 3D rendering according to the further real-time data; and
navigating the autonomous vehicle according to the revised 3D rendering.

18. The medium of claim 17, further comprising at least one of:
receiving the further real-time data from other vehicles; and
receiving the further real-time data from stationary transmitters.

19. The medium of claim 14, further comprising:
receiving incremental updates to the 3D rendering; and
revising the 3D rendering according to the real-time data and the incremental updates.

20. The medium of claim 14, further comprising:
transmitting the real-time data to a remote server storing a further 3D rendering;
wherein the remote server revises the further 3D rendering according to the real-time data.
